(19) United States
(12) Patent Application Publication
(10) Pub. No.: US 2016/0109048 A1
(43) Pub. Date: Apr. 21, 2016

(54) Access Port Seal

(71) Applicant: Graham Brigham, Sherwood Park (CA)

(72) Inventor: Graham Brigham, Sherwood Park (CA)

(21) Appl. No.: 14/887,776

(22) Filed: Oct. 20, 2015

Related U.S. Application Data
(63) Continuation-in-part of application No. 14/255,817, filed on Apr. 17, 2014, now abandoned.
Application No. 14/255,817 is a continuation-in-part of application No. 13/137,568, filed on Aug. 26, 2011, now abandoned.

(51) Int. Cl. F16L 45/00; F16L 57/04

(52) U.S. Cl. CPC F16L 45/00; F16L 57/04

(57) ABSTRACT

An apparatus is provided for sealing an opening in a metal sheath surrounding an insulated pipe, the apparatus including a base comprising an outer flange securable within the opening, and defining an inner passage therethrough, the base ring further comprising an annular ridge extending into the inner passage; a flexible waterproof body positionable within the inner passage, the body having a periphery therearound and a groove located within the periphery adapted to engage around the annular ridge; and a flexible metal element within the base.

### PRIORITY STATEMENT AND CROSS REFERENCE TO RELATED APPLICATIONS

This application is a continuation-in-part of U.S. patent application Ser. No. 14/255,817 entitled “Access Port Seal” and filed on Apr. 17, 2014, in the name of Graham Brigham; which is a continuation-in-part of U.S. patent application Ser. No. 13/137,568 entitled “Access Port Seal” and filed on Aug. 26, 2011, in the name of Graham Brigham; both of which are hereby incorporated by reference in their entirety.

### TECHNICAL FIELD OF THE INVENTION

The present invention relates to plugs in general and in particular to plugs located in insulated coverings to provide access to an interior thereof.

### BACKGROUND OF THE INVENTION

In many industries, it is frequently necessary to access pipes or other conduits to conduct inspection, maintenance and the like. Such pipes and conduits are often insulated to protect the contents of the conduit from adverse weather, temperatures, and the like. In particular, in the oil and gas industry, it is common to provide insulation around such pipes within a sheath of protective sheet metal.

Conventionally, when it has been necessary to provide access to a pipe or its contents which have an insulating layer, a hole is cut in the sheet metal and the insulation removed from that region to form an opening for access to the pipe. After the maintenance, inspection or the like has been performed on the pipe, insulation is reinserted into the cavity and a new layer of sheet metal secured over the opening to provide a patch in the original sheet metal. Problematically, such a patch has been unsatisfactory at providing the original level of insulation and protection of the pipe from adverse weather. In particular, such sheet metal patches have been known to leak when subjected to rain or melting snow.

The compromised insulation and protective sheath poses a problem for the insulation under the metal patch as well as the surrounding region as the insulation typically used for such applications is fiberglass batting or other fibrous material. Such materials are known to be intolerant of becoming wet, and being prone to compacting when damp. Such compacting of the insulation impairs the ability of the insulation to adequately insulate the pipe in that location as well as any surrounding regions which also become wet.

An additional difficulty of such patches are that once they are installed, any subsequent removal pf the patch for future maintenance or inspection will increase the size of the screw holes thereby further increasing the ability of water to enter the insulation.

### SUMMARY OF THE INVENTION

According to a first embodiment of the present invention there is disclosed an apparatus for sealing an opening in a metal sheath surrounding an insulated pipe, the apparatus comprising a waterproof body locatable within the opening, the body having a periphery therearound and a groove located within the periphery, the groove being sized and shaped to closely and sealably receive an edge of the opening therein and a flexible securing means extending from the waterproof body.

The body may be formed of a material selected from the group consisting of neoprene, rubber, silicone and closed cell foam. The body may be elongate with substantially parallel sides. The body may be circular.

The groove may have a constant radius. The groove may have a radius of less than ½ inch. The groove may be located in the middle of the peripheral edge. The apparatus may further comprise a leading surface of the peripheral edge extending from the groove by a distance greater than a trailing surface of the peripheral edge. At least one of the leading and trailing surfaces peripheral edges may be rounded.

The strap may be securable to the sheet metal. The strap may be integrally formed with the body. The apparatus further comprise a gasket securable to an edge of the opening in the sheet metal wherein the gasket is locatable within the groove of the body. The gasket may comprise a base ring. The strap may be securable to the base ring. The base ring may be integrally formed with the strap and the body.

The base may include a flexible metal element positioned within the base that may circumferentially circle the base. The flexible metal element may be made of steel.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an insulated pipe having a hole cut in the insulation for access to the pipe.

FIG. 2 is a perspective view of an apparatus according to a first embodiment of the present invention applied to the hole in the pipe.

FIG. 3 is a cross-sectional view of the apparatus of FIG. 2 as taken along the line 3-3 in FIG. 2.

FIG. 4 is a cross-sectional view of the apparatus of FIG. 2 located within a hole in pipe insulation as taken along the line 4-4 in FIG. 2.

FIG. 5 is a perspective view of an apparatus according to a further embodiment of the present invention applied to the hole in the pipe.

FIG. 6 is a cross-sectional view of the apparatus of FIG. 5 located within a hole in pipe insulation.

FIG. 7 is a top view of an apparatus according to a further embodiment of the invention showing hidden elements.

FIG. 8 is a cross sectional view thereof as taken along line 8-8 in FIG. 7.

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application), nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

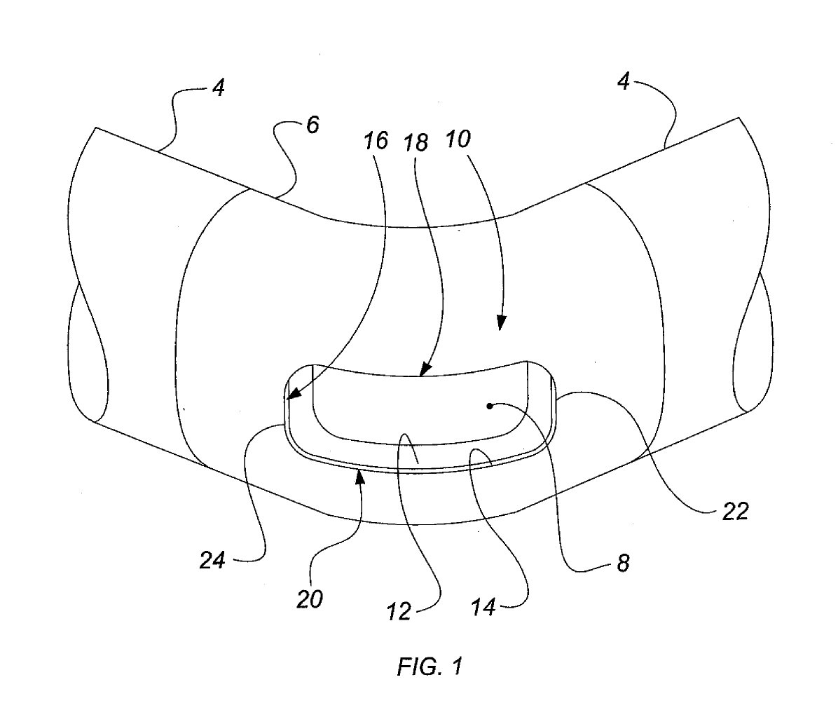

Referring to FIG. 1, an opening through pipe insulation is shown generally at 10. The pipe 8 is surrounded by an insulating layer 12 and a sheath layer 14. The opening is defined by an opening edge 16 having top and bottom straight edges, 18 and 20, respectively, and first and second arcuate portions 22 and 24 therebetween. As illustrated, the opening 10 may be located within an elbow portion 6 of the pipe 8 and pipe insulation 12; however it will be appreciated that the opening may also be located within a straight portion 4 of pipe 8 or at any other location desired by a user.

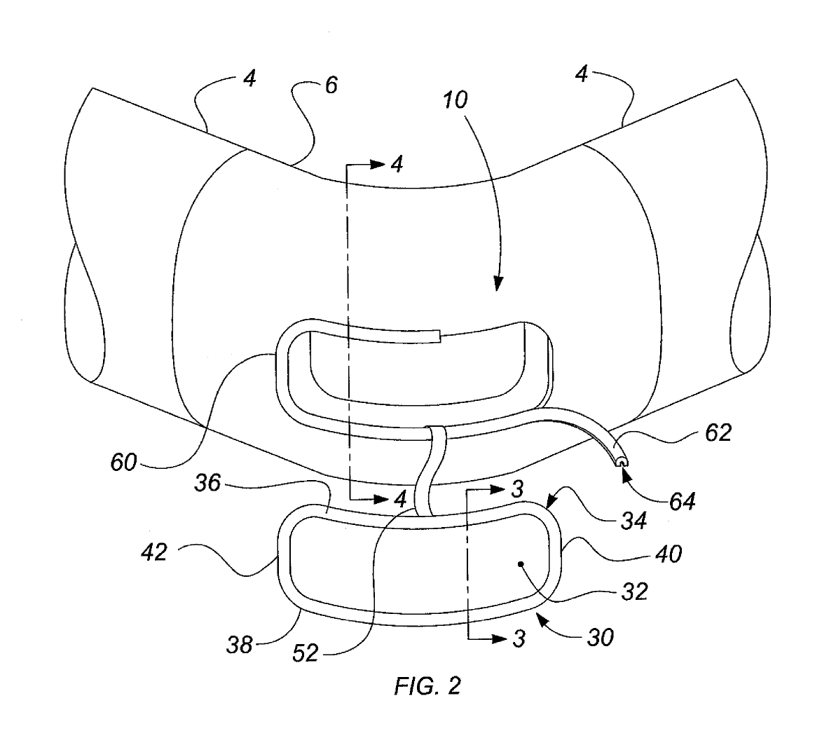

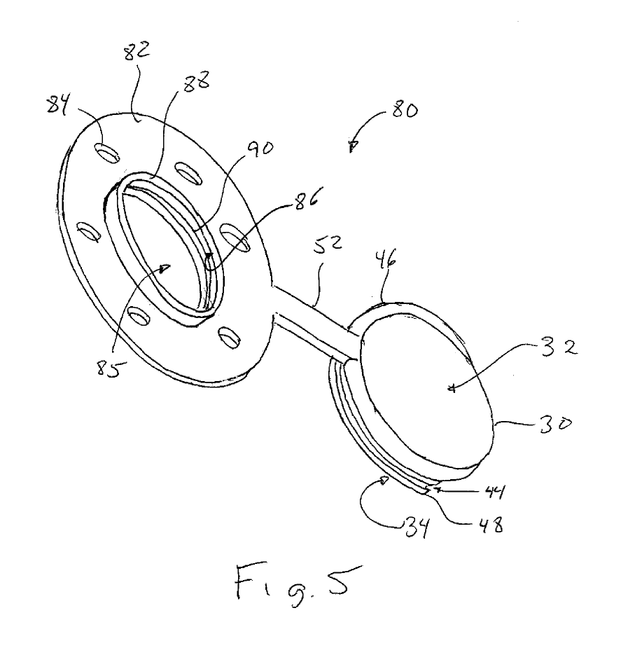

With reference to FIG. 2, the apparatus comprises a plug body 30 sized and shaped to be sealably received within the opening 10. The body 30 comprises a member having front and rear surfaces, 32 and 34, respectively, extending between top and bottom edges 36 and 38 and first and second side arcuate ends, 40 and 42, respectively. Although the body 30 is illustrated and described as having an elongate shape, it will be appreciated that other shapes may be utilized as well, such as, by way of non-limiting example, circular as illustrated in FIG. 5, oval, rectangular, square, triangular, octagonal or irregular. Additionally, although the body 30 is illustrated as being adapted for insertion into an elbow portion 6, it will be appreciated that the body may be adapted for fitting into a straight portion 4 or other section of the sheath layer 14. For use in the straight portion 4, the body 30 may have a straight profile whereas for an elbow portion 6, the body 30 may have a curved profile as illustrated matching or otherwise corresponding to the curvature of the intended section of the sheath layer 14. According to a further embodiment of the present invention, a gasket 60 may be provided around opening edge 16 of the opening as will be further described below.

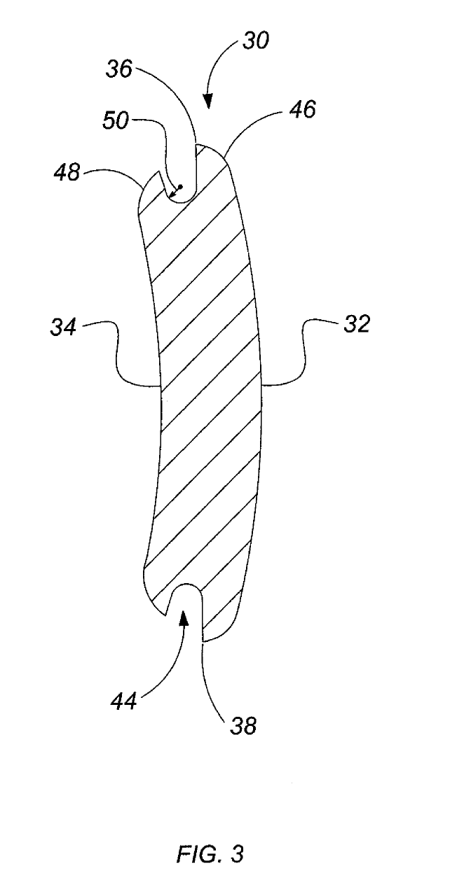

Turning now to FIG. 3, the body 30 is illustrated in cross section. The body 30 has a thickness between the front and rear surfaces 32 and 34 which may be selected to be any suitable thickness for properly sealing the opening 10. By way of non-limiting example, the body 30 may have a thickness of between ½ and 2 inches (12 and 51 mm) with a thickness of approximately 1 inch (25 mm) having been found to be particularly useful. The top and bottom edges 36 and 38 and first and second sides 40 and 42 of the body 30 define a periphery thereof. It will be appreciated that the top and bottom edges 36 and 38 are sized and shaped to correspond to the top and bottom edges 18 and 20 of the opening 10 and the first and second sides 40 and 42 are sized and shaped to correspond to the first and second arcuate portions 22 and 24 of the opening. In particular, it will be appreciated that a user may cut the opening 10 to correspond to the plug body 30 and in some instances may be provided with a cut template (not shown) to guide the user in cutting the appropriate sized and shaped opening according to known methods.

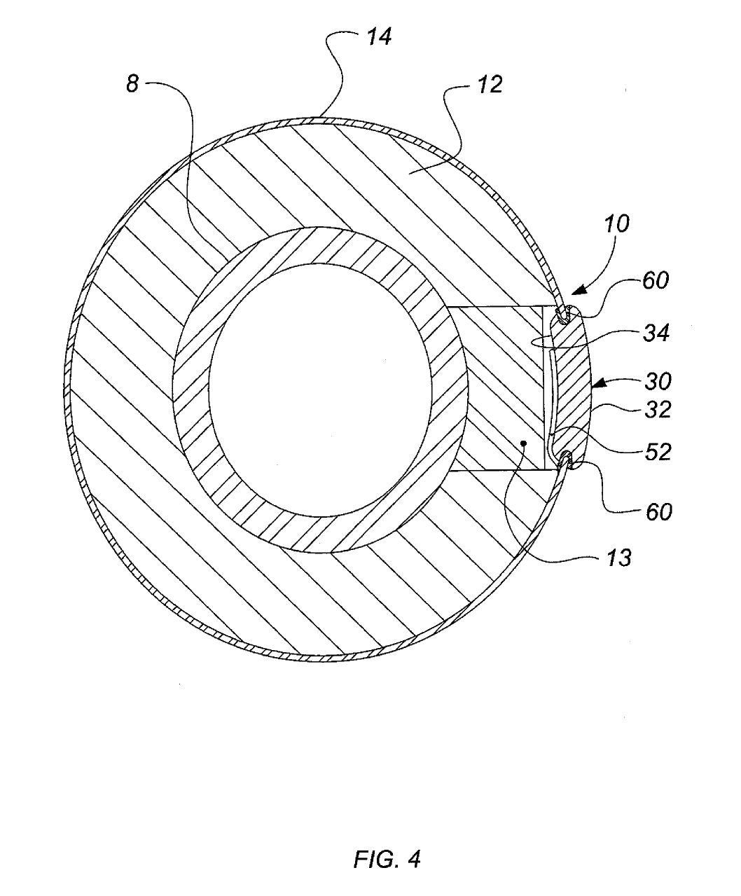

As illustrated in FIG. 3, the periphery of the body 30 is defined by the top and bottom edges 36 and 38 and first and second sides 40 and 42 and has a substantially constant profile. The body 30 also includes a groove 44 extending around the periphery and dividing the periphery into a leading and a trailing edge, 46 and 48, respectively. The leading edge 46 is disposed between the front surface 32 and the groove 44 and the trailing edge 48 is disposed between the groove and the rear surface 34 of the body 30. As illustrated, the leading and trailing edge may be rounded although it will be appreciated that other profiles may also be utilized as well, such as by way of non-limiting example, chamfered, beveled or routed. As illustrated, the groove 44 may have a semi-circular cross section having a radius generally indicated at 50 of up to ½ inch (12 mm) with a radius of ¼ inch (6 mm) having been found to be particularly useful although other profiles may be utilized as well, such as, by way of non-limiting example, v-notched, arcuate, rectangular or a slot. Optionally, a strap 52 or other suitable connector may be provided for connecting the body 30 to the sheath layer 14 wherein the strap is secured between the body 30 and an inner surface of the sheath layer 14 by any known means, such as, by way of non-limiting example, screws, welding adhesives or the like. As illustrated in FIG. 4, the strap 52 may be separate from the body 30 or may be integrally formed therewith as illustrated in FIG. 5.

The body 30 may be formed of any suitable waterproof material, such as by way of non-limiting example, neoprene, natural or synthetic rubber, silicone or closed cell foam. The body 30 may be formed of any known suitable method, such as by way of non-limiting example, casting, machining, utilizing a router or molding. A spray on protective coating may be used to further protect body 30, such as polyurea elastomer.

The gasket 60 may be of any suitable type and in one embodiment may have an outer radiused surface 62 and an inner slot 64. The outer radiused surface is sized to be sealably engaged within the groove 44 and may therefore have an outer radius of up to ½ inch (12 mm), such as by way of non-limiting example, Edge Trim sold as product ID WRE10B34 by Edge Lok Inc. of Buena Park Calif. The gasket may also include an inner slot 64 sized to be positioned over an edge of the sheath layer 14. The gasket may be provided as a roll which may then be cut by a user or may optionally be provided as part of a kit with a length selected to fully surround opening 10 as cut according to a provided template.

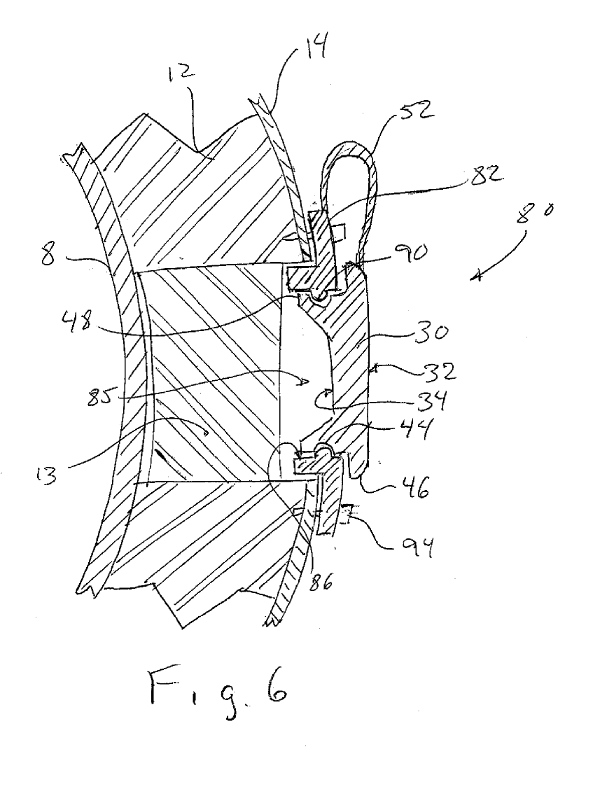

Optionally, as illustrated in FIGS. 5 and 6, the gasket 60 may comprise a base ring 80 which is securable to the inside of the opening edge 16. The base ring 80 may be formed integrally with the body 30 and strap 52 or may be formed separately therefrom and the components secured together with fasteners or the like. The base ring includes a top flange 82 having a plurality of fastener bores 84 extending therethrough. An inner cylinder 88 extends away from top flange 82 by a distance sufficient to provide an inner mounting surface 86. The top flange 82 and cylinder 88 have an inner passage 85 therethrough corresponding to the diameter or size and shape of the body 30. Although the embodiment illustrated in FIGS. 5 and 6 is illustrated as circular, any other outline as set out above may also be utilized. The inner passage 85 includes an annular ridge 90 inside of the top flange 82 sized to correspond to and be engaged within the groove 44 of the body 30 so as to retain the body 30 therein. As illustrated in FIG. 6, the base ring 80 may be secured within the opening edge 16 proximate to the outside of the sheet metal 14. Thereafter, fasteners 94 may be passed through the bores 84 to secure the base ring to the sheet metal layer 14.

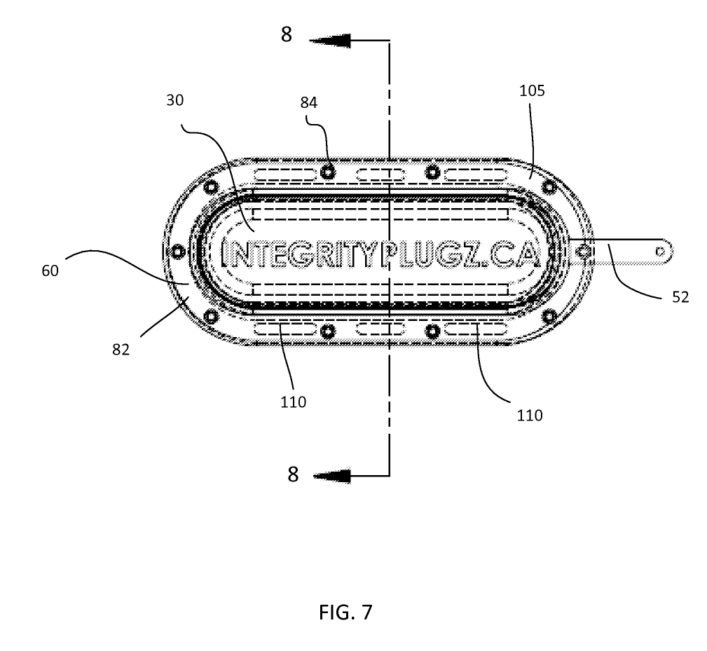

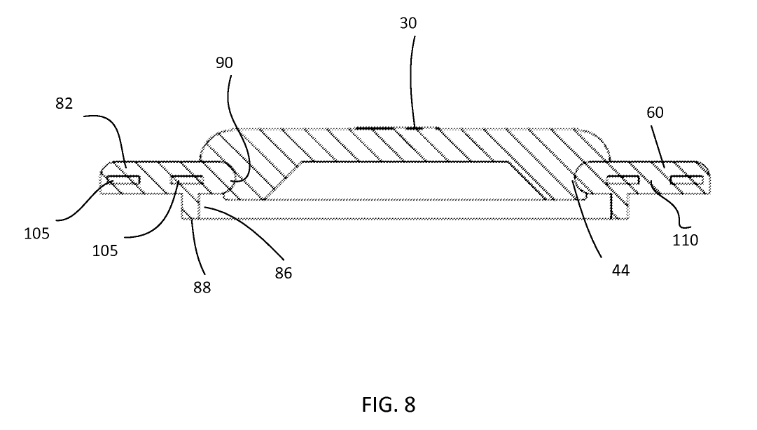

With reference to FIGS. 7 and 8, a further embodiment is shown, in which gasket 60 includes a flexible metal element 105 may be circumferentially placed within gasket 60 allowing gasket 60 to be bent into a shape to fit a curve or irregularity in pipe 8. Flexible element 105 may be made of black mild steel, or tin, aluminum, a zinc alloy, galvanized steel, copper, plastics, or other material that is flexible and maintains the shape it is bend into, and is configured to allow gasket 60 to be easily bent into a position that will be maintained by metal element 105. Metal element 105 may extend entirely around the circumference of gasket 60, or may be positioned at selected parts of gasket 60. Metal element 105 may be placed entirely within gasket 60 to protect metal element 105 from the elements. In this embodiment body 30 is flexible to be bent into a shape to fit securely into gasket 60 as described above. As shown in FIGS. 7 and 7, metal ring 105 may include cut outs 110 to reduce the amount of metal needed in metal ring 105.

In operation a user may cut an opening 10, optionally with the use of a provided template matched to the body 30 through the sheath layer 14 and insulating layer 12 surrounding a pipe 8. Thereafter the cut out insulation and sheath layer opening portions may be removed to provide access to the pipe for maintenance, inspection and the like. After the user has completed their activities requiring access to the pipe 8, the removed insulation or replacement insulation, generally indicated at 13 in FIG. 4 may then be replaced within the opening. The gasket 60 may then be bent into the proper shape and then installed over the edge of the sheath layer and the body 30 inserted such that the gasket 60 is sealably received within the groove as illustrated in FIG. 4. If future access is required to the pipe 8, the body 30 and replacement insulation 13 may be removed to provide access thereto and thereafter reinserted into the opening 10.

Although the particular preferred embodiments of the invention have been disclosed in detail for illustrative purposes, it will be recognized that variations or modifications of the disclosed apparatus lie within the scope of the present invention.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various embodiments described above may omit some elements, include other elements, and/or place elements in a different position than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form.

While specific embodiments of the invention have been described and illustrated, such embodiments should be considered illustrative of the invention only and not as limiting the invention as construed in accordance with the accompanying claims.

What is claimed is:

1. An apparatus for sealing an opening in a metal sheath surrounding an insulated pipe, the apparatus comprising:
a base comprising an outer flange securable within the opening, and defining an inner passage therethrough, the base ring further comprising an annular ridge extending into the inner passage;
a flexible waterproof body positionable within the inner passage, the body having a periphery therearound and a groove located within the periphery adapted to engage around the annular ridge; and
a flexible metal element within the base.

2. The apparatus of claim 1 wherein the flexible element circumferentially surrounds the inner passage.

3. The apparatus of claim 2 wherein the flexible metal element is made of steel.

4. The apparatus of claim 3 wherein the body is formed of a material selected from the group consisting of neoprene, rubber, silicone and closed cell foam.

5. The apparatus of claim 4 wherein the body is elongate with substantially parallel sides.

6. The apparatus of claim 4 wherein the body is circular.

7. The apparatus of claim 5 wherein the groove has a constant radius.

8. The apparatus of claim 7 wherein the groove has a radius of less than ½ inch.

9. The apparatus of claim 8 wherein the groove is located in the middle of the peripheral edge.

10. The apparatus of claim 9 further comprising a leading surface of the periphery extending from the groove by a distance greater than a trailing surface of the periphery.

11. The apparatus of claim 10 wherein at least one of the leading and trailing surface peripheral edges is rounded.

12. The apparatus of claim 11 wherein the apparatus further comprises a securing means securing the base to the body.

13. The apparatus of claim 12 wherein the securing means is a strap.

14. The apparatus of claim 13 wherein the strap is integrally formed with the body.

15. The apparatus of claim 14 wherein the base ring is integrally formed with the strap and the body.

16. The apparatus of claim 15 wherein the body is at least partially coated with a polyurea elastomer.
